(19) United States
(12) Patent Application Publication
(10) Pub. No.: US 2017/0011095 A1
(43) Pub. Date: Jan. 12, 2017

(54) PROCESSING SEARCH QUERIES FOR OPEN EDUCATION RESOURCES

(71) Applicant: FUJITSU LIMITED, Kawasaki-shi (JP)

(72) Inventors: Jun WANG, San Jose, CA (US); Kanji UCHINO, San Jose, CA (US)

(21) Appl. No.: 14/796,978

(22) Filed: Jul. 10, 2015

(51) Int. Cl. G06F 17/30

(52) U.S. Cl. CPC G06F 17/30528; G06F 17/30867; G06F 17/3053

(57) ABSTRACT

A method to process search queries for open education resources may include receiving a search query related to a topic over a network at a computing system. The method may also include selecting, by the computing system, course learning material from a set of course learning materials based on a first topic prevalence score for the course learning material, a second topic prevalence score for a first publication, and a third topic prevalence score for a second publication. The method may further include generating, by the computing system, a search query result that identifies the course learning material as being responsive to the search query. The course learning material, the first publication, and the second publication may be associated with an author.

### FIELD

The embodiments discussed herein are related to processing search queries for open education resources.

### BACKGROUND

Open education generally refers to online learning programs or courses that are made publicly available on the Internet or other public access networks. Examples of open education programs may include e-learning programs, Open Courseware (OCW), Massive Open Online Courses (MOOC), and the like. Various universities and other educational institutions offer open education programs free-of-charge to the general public without imposing any academic admission conditions or prerequisites. Participation in an open education program typically allows a user to access course learning materials relating to any of a variety of topics. The course learning materials may include lecture notes and/or video recordings of lectures by an instructor at the educational institution.

Various open education programs are currently offered by a number of educational institutions, including, among others, MIT, Yale, the University of Michigan, the University of California Berkeley, and Stanford, and the number of educational institutions offering open education programs has increased substantially since the inception of open education a little over a decade ago. With the proliferation of open education programs, there has been a concomitant increase in the number of available course learning materials.

The subject matter claimed herein is not limited to embodiments that solve any disadvantages or that operate only in environments such as those described above. Rather, this background is only provided to illustrate one example technology area where some embodiments described herein may be practiced. Furthermore, unless otherwise indicated, the materials described in the background section are not prior art to the claims in the present application and are not admitted to be prior art by inclusion in this section.

### SUMMARY

According to an aspect of an embodiment, a method to process search queries is described in this application. The method may include receiving a search query related to a topic over a network at a computing system. The method may also include selecting, by the computing system, a course learning material from a set of course learning materials based on a first topic prevalence score for the course learning material, a second topic prevalence score for a first publication, and a third topic prevalence score for a second publication. The method may further include generating, by the computing system, a search query result that identifies the course learning material as being responsive to the search query.

Before receiving the search query, the computer-implemented method may include determining the first topic prevalence score for the course learning material based on a relationship between a quantity of first knowledge points extracted from the course learning material and a quantity of a subset of the first knowledge points. The subset of the first knowledge points may be associated with the topic. The course learning material may be associated with an author. Before receiving the search query, the computer-implemented method may also include determining the second topic prevalence score for the first publication based on a relationship between a quantity of second knowledge points extracted from the first article and a quantity of a subset of the second knowledge points. The subset of the second knowledge points may be associated with the topic. The first publication may be associated with the author. Additionally, before receiving the search query, the computer-implemented method may include determining the third topic prevalence score for the second publication based on a relationship between a quantity of third knowledge points extracted from the second publication and a quantity of a subset of the third knowledge points. The subset of the third knowledge points may be associated with the topic. The second publication may be associated with the author.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 is a block diagram of an example embodiment of a computing system that may be included in the operating environment of FIG. 1;

FIG. 3 illustrates an example flow diagram of a method that may be implemented in the operating environment of FIG. 1;

FIGS. 4A-4B illustrate an example flow diagram of another method that may be implemented in the operating environment of FIG. 1;

FIG. 5 illustrates an example flow diagram of a method to process search queries for open education resources;

FIG. 6 illustrates an example algorithm which may be used to generate a topic-specific expertise profile; and

FIG. 7 illustrates an example algorithm which may be used to generate a topic-specific recommendation score.

### DESCRIPTION OF EMBODIMENTS

The World Wide Web can be described as an ocean of information and knowledge usable for learning. More and more Open Educational Resources (OERs) are available online, and especially, with new development of Massive Open Online Courses (MOOC), educational materials that used to cost thousands of dollars and were available only to an elite few now have become ubiquitous and more widely available. Theoretically, learners can flexibly choose the subjects they want and build up their own curriculum and study schedule which suits their personal needs. However, most of the OERs are scattered around the Web and are not well described or structured, which may result in significant problems in their use, search, organization and management. Thus, it may not be easy for learners to locate and judge which course learning materials are the right ones for them from the massive number online learning materials. The difficulty in selecting online learning material may be one of the reasons why education through personalized informal learning may still be less effective than education through personal interaction in a classroom.

Some embodiments described in the present disclosure may be used to provide an effective approach to process search queries for OERs. In some embodiments, a topic of interest to the user may be determined from the search query, and processing of the search query may include selecting course learning material from a set of course learning materials based on one or more of the following: a topic-specific expertise score of an author of the course learning material, a prevalence or distribution of the topic in the course learning material, and a baseline expertise score of the author. In these and other embodiments, the topic-specific expertise score may reflect an expertise of the author with respect to the topic and may be determined based on one or more of the following: a prevalence of the topic in each of one or more publications associated with the author, an importance or influence of each of the one or more publications, and a personal importance or influence of the author. The influence of each of the one or more publications associated with the author and the influence of the author may be determined based on one or more measurements obtained from a citation network and co-author network of publications, respectively. In some embodiments, a search query result may be generated that identifies the course learning material as being responsive to the search query.

The term “publication,” as referred to in the present disclosure, may include a published article from a scientific journal, conference, newspaper, or magazine. The published article may be peer-reviewed and may be available via a network, for example, the Internet. Publications may be available in scientific literature databases. Throughout the present disclosure, the term “knowledge point” is used to refer to “concepts” of the course learning materials and/or publications. A knowledge point may correspond to technology key terms or phrases in the course learning materials and/or publications. For example, one or more course learning materials may pertain to courses on machine learning. The knowledge points may correspond to technology terms discussed in the courses such as “neural networks”, “statistical inference”, “clustering”, and “structural predictions.” In some embodiments described in the present disclosure, knowledge points may be extracted and each of the knowledge points may be labeled based on one or more topics associated with the corresponding knowledge point.

The processing of search queries as described in the present disclosure may include generating a search query result that identifies one or more course learning materials in open education systems and/or in closed learning management systems as being responsive to the search query. For example, the processing of search queries as described in the present disclosure may be applied in learning material search systems, in open learning material repositories to generate the search query result. As another example, the processing of search queries as described in the present disclosure may be applied in university learning management systems requiring user authentication and/or in other closed learning management systems to generate the search query result.

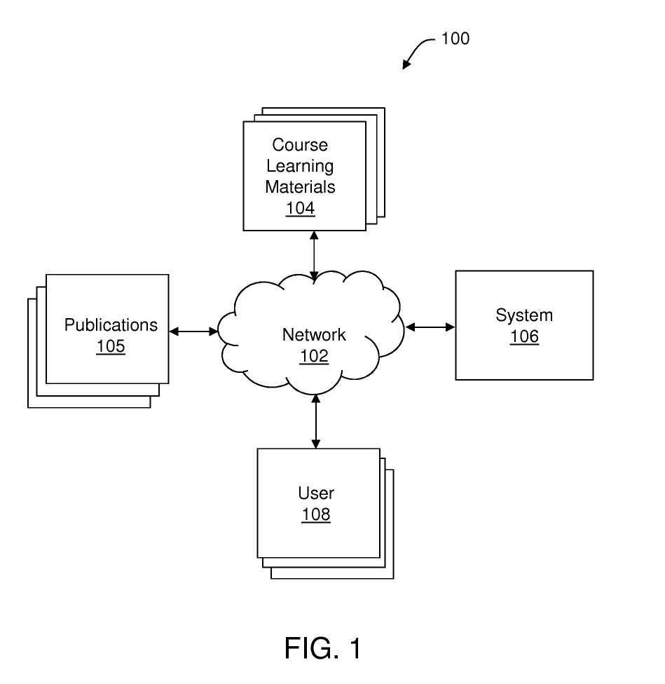

FIG. 1 illustrates a block diagram of an example operating environment 100 in which some embodiments may be implemented, arranged in accordance with at least one embodiment described in the present disclosure. The operating environment 100 may include a network 102, course learning materials 104, publications 105, a search query processing system (hereinafter “system”) 106, and at least one end user (hereinafter “user”) 108.

In general, the network 102 may include one or more wide area networks (WANs) and/or local area networks (LANs) that enable the system 106 and/or the user 108 to access the learning materials 104 and/or to communicate with each other. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

The course learning materials 104 may include any of a variety of online resources such as open courseware (OCW) learning materials, massive open online courses (MOOC) learning materials, course pages for courses taught at educational institutions by individuals including professors and lecturers, lecture notes and/or recordings (e.g., video and/or audio recordings) associated with such courses, or the like or any combination thereof. Course learning materials 104 may include, for example, lecture notes, syllabi, videos, video transcripts, example problems/solutions, lecture slides, and other materials. A particular course learning material 104 may have one or more authors. An author of the particular course learning material 104 may also be the author of one or more publications 105. Any two particular course learning materials 104 may share one or more authors and/or have different authors. The course learning materials 104 may be accessible on websites hosted by one or more corresponding web servers communicatively coupled to the Internet. Although FIG. 1 illustrates course learning materials 104 as being separate from the publications 105, in some embodiments, the course learning materials 104 may include one or more publications 105.

The user 108 may include a person and/or other entity or machine that desires to find course learning materials 104 that satisfy or match a particular search query, which may be directed to or relate to a particular topic. Example search queries may include one or more keywords or search terms and/or a request to identify course learning materials 104 that are related to a particular topic. Although not separately illustrated, the user 108 typically communicates with the network 102 using a computing device corresponding to the user 108. The computing device may include, but is not limited to, a desktop computer, a laptop computer, a tablet computer, a mobile phone, a smartphone, a personal digital assistant (PDA), or other suitable computing device.

In general, the system 106 may be configured to process a search query received from the user 108. The system 106 may be configured to generate a search query result that recommends one or more course learning materials 104 that are likely to be helpful to the user 108 in understanding a topic to which the search query relates. In some embodiments, in order to generate the search query result, the system 106 may automatically analyze a set of course learning materials 104 to extract knowledge points, assign topic labels to the knowledge points, and determine, based on the topic labels, a prevalence or distribution of a topic in each course learning material 104 of the set of course learning materials 104. In some embodiments, a total number of topic labels which may be assigned to knowledge points in the set of course learning materials 104 and/or the publications 105 may be a specified or pre-determined number. In some embodiments, the topic may be related to the search query. The system 106 may generate a topic prevalence score for each course learning material 104 of the set of course learning materials 104, reflecting a prevalence of the topic in the corresponding course learning material 104. The prevalence of the topic may be determined in various ways. For example, in some embodiments, the prevalence of the topic in the corresponding course learning material 104 may be determined using topic model analysis. For example, given the set of course learning materials 104 and a specified number of topics, a topic model may automatically assign one or more topic labels to one or more knowledge points in the set of course learning materials based on topics associated with the one or more knowledge points. The prevalence of the topic in the corresponding course learning material 104 may be based on a relationship between a quantity of knowledge points extracted from the corresponding course learning material 104 and a quantity of a subset of the knowledge points that are associated with the topic. In these and other embodiments, the quantity of the subset of the knowledge points may be determined based on a number of topic labels associated with the topic in the corresponding course learning material 104.

In some embodiments, for each publication 105, the system 106 may determine, in addition to the one or more topic prevalence scores, a publication influence score. In some embodiments, the system 106 may adjust the publication prevalence score with respect to the topic for each of the publications 105 based on the publication influence score for the corresponding publication 105. In some embodiments, the system 106 may also adjust the topic prevalence scores with respect to the topic for each of the publications 105 based on a personal influence score of a particular author of the corresponding publication 105. In some embodiments, the system 106 may determine a topic-specific expertise score for the particular author, reflecting the particular author's expertise on the topic, based on the adjusted topic prevalence scores for each of the publications 105 associated with the author.

In some embodiments, the system 106 may determine the topic-specific recommendation score for each of the course learning materials 104 in the set of course learning materials 104 that have the particular author based on one or more of the following: the topic-specific expertise score for the particular author, a baseline expertise score for the particular author, and a particular prevalence score corresponding to the prevalence of the topic in the corresponding course learning material 104.

In some embodiments, the baseline expertise score for a particular author may be determined based on a total quantity of knowledge points extracted from course materials and/or publications associated with the particular author. In some embodiments, each of the knowledge points of the total quantity of knowledge points may be labeled based on one or more topics associated with the knowledge points, and the baseline expertise score may correspond to a total quantity of topic labels in the course materials and/or publications associated with the particular author. In some embodiments, each topic label may have a same value as another topic label, and all topic labels may contribute equally to the baseline expertise score of the particular author.

In some embodiments, the system 106 may generate the search query result based on the topic-specific recommendation scores determined for each of the course learning materials 104 in the set of course learning materials 104. For example, a first topic-specific recommendation score for a first course learning material, determined with respect to a particular topic, and a second topic-specific recommendation score for a second course learning material, determined with respect to the particular topic, may determine whether the first course learning material and/or the second course learning material are identified as being responsive to a search query related to the particular topic. In some embodiments, in response to the first topic-specific recommendation score and the second topic-specific recommendation score reaching or exceeding a threshold value, both the first and second course learning materials may be identified as responsive to the search query. In some embodiments, the first course learning material and not the second course learning material may be identified as being responsive to the search query in response to the first topic-specific recommendation score being greater than the second topic-specific recommendation score.

In some embodiments, the system 106 may sort the set based on the topic-specific recommendation scores determined for each of the course learning materials 104 in the set of course learning materials 104. For example, the system 106 may order the course learning materials 104 in the set based on their corresponding topic-specific recommendation scores. Based on the order, the system 106 may generate the search query result that identifies one or more of the course learning materials 104 of the set of course learning materials 104 as being responsive to the search query. For example, the system 106 may generate the search query result that identifies as being responsive to the search query one or more of the course learning materials 104 of the set that have topic-specific recommendation scores higher than other of the course learning materials 104 of the set of course learning materials 104.

In some embodiments, multiple topic-specific expertise scores may be determined for a particular author, depending on, for example, a number of topics in the set of course learning materials 104 and/or a number of topics in course learning materials in the set of course learning materials 104 that are associated with the particular author. Further, multiple topic-specific recommendation scores may be determined for a particular course learning material 104 depending on, for example, a number of topics in the particular course learning material 104, which may be determined based on how many different topic labels are assigned to the knowledge points in the particular course learning material 104.

A topic-specific recommendation score for a course learning material 104 may be determined by the system 106 based on topic prevalence scores reflecting a prevalence of a single topic in publications 105 associated with a same author as the course learning material 104. In some embodiments, the topic-specific recommendation score for the course learning material 104 may also be based on a topic prevalence score that reflects a prevalence of the single topic in the course learning material 104. Thus, the topic-specific recommendation score for the course learning material 104 and the topic-specific expertise score for the author may be determined with respect to the single topic.

For example, the system 106 may determine a topic-specific recommendation score for a course learning material 104 associated with an author as follows. A first topic prevalence score may be determined with respect to a topic in the first publication 105, the first publication 105 being associated with the author. A second topic prevalence score may be determined with respect to the same topic in the second publication 105, the second publication 105 being associated with the author. A total score and topic-specific expertise score may be determined for the author based on the first and second topic prevalence scores. A third topic prevalence score may be determined with respect to the same topic in the course learning material. A topic-specific recommendation score for the course learning material may be based on the topic-specific expertise score and/or a prevalence of the same topic in the course learning material. Thus, the topic-specific recommendation score for the course learning material may be determined with respect to a single topic. It is assumed for simplicity in this example that the author of the course learning material is associated with a first and second publication 105. However, it is understood that the author may be associated with additional publications 105 for which topic prevalence scores may be determined. In these and other embodiments, the topic-specific expertise score for the author may also be based on publication influence scores for the first and second publications 105 and a personal influence score of the author. In these and other embodiments, the topic-specific recommendation score for the course learning material may also be based on a baseline expertise score of the author.

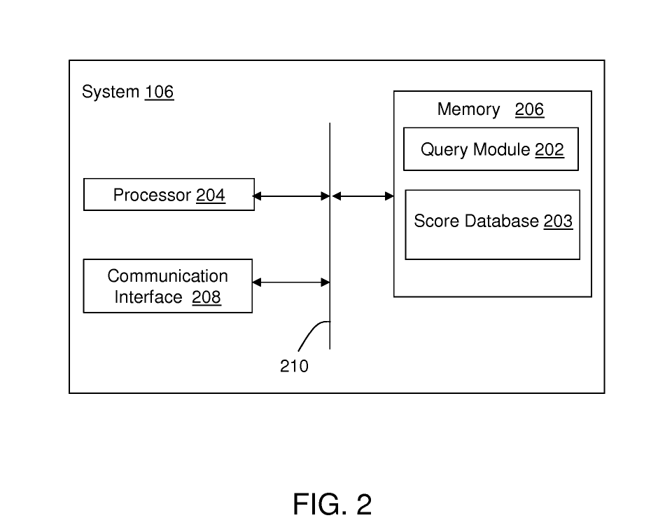

FIG. 2 is a block diagram of an example embodiment of the system 106 of FIG. 1, arranged in accordance with at least one embodiment described in the present disclosure. As illustrated, the system 106 may include a processor 204, a memory 206, and a communication interface 208. The processor 204, the memory 206, and the communication interface 208 may be communicatively coupled via a communication bus 210. The communication bus 210 may include, but is not limited to, a memory bus, a storage interface bus, a bus/interface controller, an interface bus, or the like or any combination thereof.

In general, the communication interface 208 may facilitate communications over a network, such as the network 102 of FIG. 1. The communication interface 208 may include, but is not limited to, a network interface card, a network adapter, a LAN adapter, or other suitable communication interfaces.

The processor 204 may be configured to execute computer instructions that cause the system 106 to perform the functions and operations described in the present disclosure. For example, in general, the processor 204 may be configured to determine a topic prevalence score for course learning material and publications. As another example, the processor 204 may be configured to receive a search query related to a topic over the network, select course learning material from a set of course learning materials based on a topic prevalence score for the course learning material and topic prevalence scores for one or more publications that are associated with the author of the course learning material, and generate a search query result that identifies the course learning material as being responsive to the search query. The processor 204 may include, but is not limited to, a processor, a multi-core processor, a microprocessor (μP), a controller, a microcontroller (μC), a central processing unit (CPU), a digital signal processor (DSP), any combination thereof, or other suitable processor.

Computer instructions may be loaded into the memory 206 for execution by the processor 204. For example, the computer instructions may be in the form of one or more modules, such as, but not limited to, a query module 202. In some embodiments, data generated, received, and/or operated on during performance of the functions and operations may be at least temporarily stored in the memory 206. Moreover, the memory 206 may include volatile storage such as random access memory (RAM). More generally, the system 106 may include a tangible computer-readable storage medium such as, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible computer-readable storage medium.

In some embodiments, the memory 206 may include a score database 203, which may store various scores for a set of course learning materials that may be used in processing a search query. For example, in some embodiments, the query module 202 may be configured to determine a topic prevalence score for each course learning material in a set of course learning materials, and the topic prevalence score may be stored in the score database 203. As another example, in some embodiments, the query module 202 may be configured to determine a topic expertise score for one or more authors of the set of course learning materials, and the topic expertise scores may be stored in the score database 203. As a further example, in some embodiments, the query module 202 may be configured to determine a baseline expertise score for one or more authors of the set of course learning materials, and the baseline expertise scores may be stored in the score database 203. As yet another example, in some embodiments, the query module 202 may be configured to determine a publication influence score for one or more publications and/or a personal influence score for one or more authors of the set, and the publication influence scores and/or the personal influence scores may be stored in the score database 203. Scores stored in the score database 203 may be determined by the query module 202 before receiving the search query or may be determined when a search query is input by the user and received by the query module 202.

In some embodiments, before determining topic prevalence scores for the set of course learning materials, which may be stored in the memory 206, the query module 202 may also be configured to automatically analyze the set of course learning materials to extract knowledge points. In these and other embodiments, the knowledge points extracted from the set of course learning materials may be fine-granularity knowledge points and may be associated with various topics. The knowledge points may include, for example, “graphical models,” “receptive fields,” and “Gaussian process.” The query module 202 may be configured to extract knowledge points from the course learning materials in the set as described, for example, in U.S. application Ser. No. 14/796,838, entitled: “EXTRACTION OF KNOWLEDGE POINTS AND RELATIONS FROM LEARNING MATERIALS,” filed Jul. 10, 2015, and U.S. application Ser. No. 14/796,872, entitled: “RANKING OF SEGMENTS OF LEARNING MATERIALS,” filed Jul. 10, 2015, which are incorporated in the present disclosure by reference in its entirety.

In some embodiments, the query module 202 may be configured to crawl course learning materials to extract meta-data including, for example, names of lecturers, professors, or other authors who may be offering courses and/or course learning materials. In these and other embodiments, the query module 202 may be configured to apply page format and layout analysis to crawled course learning materials to detect sequence borders such as line breaks, table cell borders, sentence borders, and specific punctuations. The course learning materials may be segmented into a batch of sequences, tokens, or words based on the detected sequence borders. With pre-processing including, for example, normalizing pluralities and removing specific punctuation, individual sequences may be fed into a generalized suffix tree, which may offer an efficient data structure to quickly find repeated sub-sequences and/or phrases as candidate knowledge points. Each knowledge point instance that occurs in the generalized suffix tree may contain related information, for example, positions in a source sequence and source course learning material. Post-processing may be applied to filter our candidate knowledge point phrases that start or end with auxiliary stop-words (e.g. conjunctions, prepositions, and/or personal pronouns), and to acquire statistical information about each candidate knowledge point phrase. For example, a frequency threshold may be used to filter rare candidate knowledge points, and mutual information and branching entropy may be used to deal with overlapped candidates. For example, “statistical machine learning” and “machine learning” are identified as knowledge points, but “statistical machine” may be identified as invalid. In addition to heuristic rules, specific operations based on machine learning may be applied to estimate parameters of statistical information and to refine candidate knowledge points as well.

In some embodiments, the query module 202 may be configured to assign topic labels to the knowledge points. For example, particular knowledge points “topic model,” “Hidden Markov model,” and “conditional random field” may relate to a topic of “graphical models” and may each be assigned a topic label corresponding to the topic “graphical models.” As another example, particular knowledge points “receptive field,” “spiking neuron,” and “firing rate” may relate to a topic of “neural activity” and may each be assigned a topic label corresponding to the topic “neural activity.” In some embodiments, a particular knowledge point may be assigned more than one topic label.

In some embodiments, the query module 202 may be configured to determine one or more topic prevalence scores for each of the course learning materials in the set of course learning materials based on the topic labels in the corresponding course learning material. For example, the query module 202 may extract knowledge points from a particular course learning material that include knowledge points labeled with different topic labels and knowledge points labeled with the same topic labels. In some embodiments, the knowledge points extracted may include a total quantity of knowledge points in the course learning material. The query module 202 may determine a subset of the knowledge points that are associated with a topic related to the search query. The query module 202 may determine a particular topic prevalence score for the particular course learning material based on a relationship between a quantity of the knowledge points and a quantity of the subset of the knowledge points that are associated with the topic. For example, the quantity of the subset of the knowledge points that are associated with the topic may be divided by the quantity of the knowledge points to determine a percentage or absolute value upon which the particular topic prevalence score may be based. The percentage may be referred to as a topic distribution.

In some embodiments, the query module 202 may also determine a subset of the knowledge points that are associated with another topic. The query module 202 may determine another particular topic prevalence score for the particular course learning material based on a relationship between a quantity of the knowledge points and a quantity of the subset of the knowledge points that are associated with the other topic. For example, the quantity of the subset of the knowledge points that are associated with the other topic may be divided by the quantity of the knowledge points to determine a percentage upon which the particular topic prevalence score may be based.

In some embodiments, the query module 202 may be configured to determine a personal influence score for one or more authors of the set of course learning materials. The personal influence score may reflect the corresponding author's impact or community influence and may be based on one or more measurements obtained from a co-author network or similar collaborative network constructed from multiple publications. The one or more measurements may include a centrality measurement such betweenness of the author in the co-author network. In the co-author network, each node of the co-author network may be an author of the set of course learning materials, and each link between two nodes may represent co-authorship in at least one publication. The weight of a link may be based on a number of publications that two authors collaborated on or the links may be unweighted. The one or more measurements may include, for example, a betweenness centrality measurement. In some embodiments, the one or more measurements obtained from the co-author network may be normalized on a scale of, for example, one (1) to ten (10) or zero (0) to one (1) before the measurements may be used to obtain the personal influence score for the particular author.

In some embodiments, the recommendation module 202 may be configured to determine a publication influence score for one or more publications which may reflect the corresponding publication's impact or community influence. In some embodiments, the query module 202 may be configured to determine the publication influence score for a particular publication based on one or more measurements, for example, PageRank, obtained from a citation network constructed from the set of course learning materials. In some embodiments, the one or more measurements obtained from the citation network may be normalized on a scale of, for example, one (1) to ten (10) or zero (0) and one (1) before the measurements may be used to obtain the publication influence score for the particular publication.

In some embodiments, the query module 202 may be configured to determine a topic expertise score for one or more authors of the set of course learning materials with respect to a topic. The query module 202 may determine the topic-specific expertise score of a particular author according to the following formula in some embodiments:

ES=PI×(Σᵢ₌₁ⁿAᵢ×Tᵢ),

In the above formula, ES may represent the topic-specific expertise score, PI may represent the personal influence score of the author, n may represent a total number of the publications associated with the author, Aᵢ with i ranging from 1 to n may represent a publication influence score of each of the n number of publications, and Tᵢ with i ranging from 1 to n may represent a topic prevalence score of each of the n number of publications. In some embodiments, Aᵢ×Tᵢ may represent an adjusted publication topic prevalence score and Σᵢ₌₁ⁿAᵢ×Tᵢ may represent a combined adjusted topic prevalence score for the author with respect to the topic. In some embodiments, the adjusted prevalence scores and/or the combined adjusted topic prevalence score for the author may be stored in the score database 203.

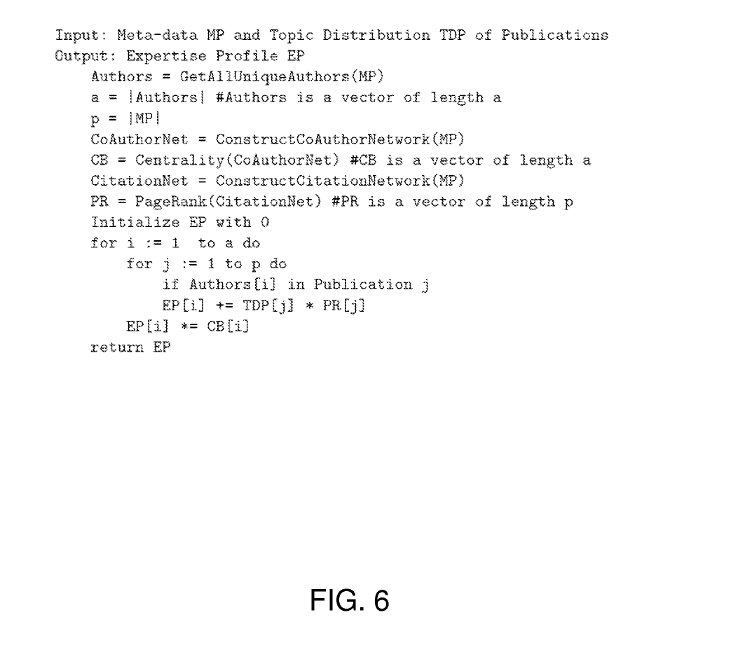

In response to the author of a course material being associated with one or more publications, the query module 202 may generate a topic-specific expertise profile for the author. FIG. 6 illustrates an example algorithm to generate the topic-specific expertise profile. The query module 202 may determine whether or not the topic-specific expertise profile has been generated for the author. In response to determining that the topic-specific expertise profile has been generated for the author, the query module 202 may determine the topic-specific expertise score based on the topic-specific expertise profile.

In some embodiments, the query module 202 may be configured to determine a baseline expertise score for one or more authors of the set of course learning materials.

In some embodiments, the query module 202 may be configured to determine a topic-specific recommendation score for a particular course learning material of the set of course learning materials. The query module 202 may determine the topic-specific recommendation score for the particular course learning material according to the following formula in some embodiments:

RS=(ES+B)×FT,

In the above formula, RS may represent the topic-specific recommendation score, ES may represent the topic-specific expertise score, B may represent the baseline expertise score, and FT may represent the first topic prevalence score. In some embodiments, the above formula may be used to determine the topic-specific recommendation score for the particular course learning material, a value of which may determine whether or not the search query result identify the particular course learning material as being responsive to the search query.

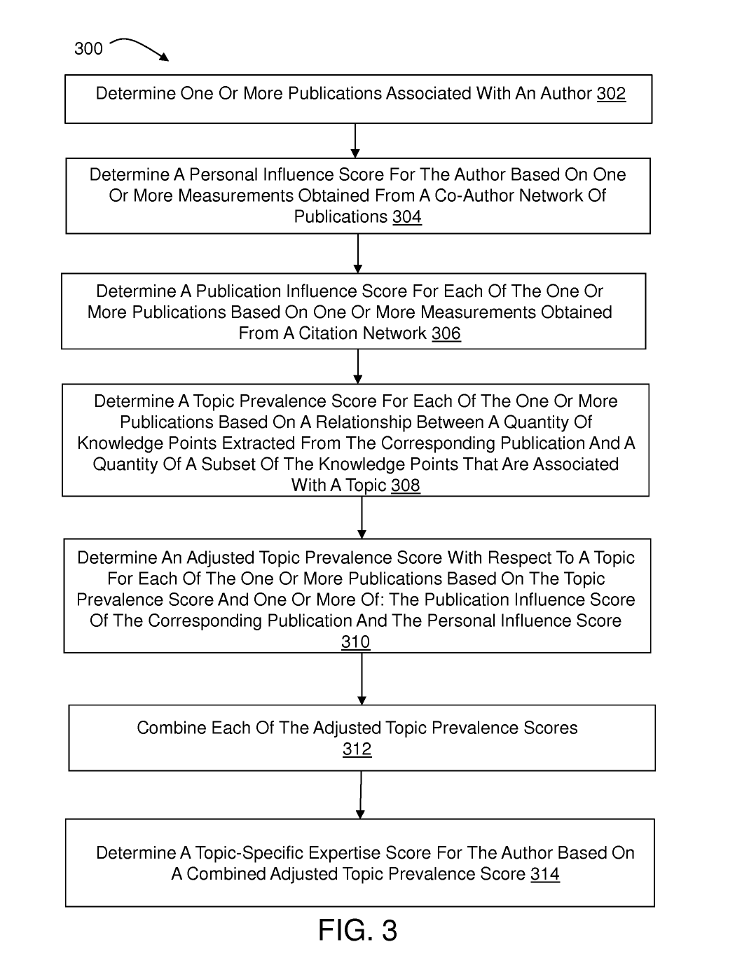

FIG. 3 illustrates an example flow diagram of a method 300 that may be implemented in the operating environment of FIG. 1, arranged in accordance with at least one embodiment described in the present disclosure. One or more operations associated with the method 300 may be implemented, in some embodiments, by the system 106 of FIG. 1. Similarly, one or more operations associated the method 300 may be implemented, in some embodiments, by the system 106 of FIG. 2. For example, the processor 204 of FIG. 2 may be configured to perform one or more of the operations associated with the method 300 by executing program instructions of the query module 202. Although illustrated as discrete blocks, various blocks may be divided into additional blocks, combined into fewer blocks, or eliminated, depending on the desired implementation.

The method 300 may begin at block 302, where one or more publications associated with an author may be determined. The author may be associated with the publications by, for example, being a named author of the publications. For example, the author may be a first author, second author, third author, etc. of the one or more publications. Block 302 may be followed by block 304.

At block 304, a personal influence score for the author may be determined based on one or more measurements obtained from a co-author network of publications. Block 304 may be followed by block 306.

At block 306, a publication influence score may be determined for each of the one or more publications based on one or more measurements obtained from a citation network of publications. Block 306 may be followed by block 308.

At block 308, a topic prevalence score may be determined for each of the one or more publications based on a relationship between a quantity of knowledge points extracted from the corresponding publication and a quantity of a subset of the knowledge points that are associated with a topic, determined using topic model analysis. In some embodiments, the topic may be related to a search query received from the user. Block 308 may be followed by block 310.

At block 310, an adjusted publication topic prevalence score with respect to a topic may be determined for each of the one or more publications based on the topic prevalence score and one or more of: the publication influence score of the corresponding publication and the personal influence score. The topic may be related to a search query. Block 310 may be followed by block 312.

At block 312, each of the adjusted publication topic prevalence scores may be combined to obtain a combined adjusted topic prevalence score for the author. Block 312 may be followed by block 314.

At block 314, a topic-specific expertise score may be determined for the author based on the combined adjusted topic prevalence score of the author and the personal influence score. The topic-specific expertise score may reflect the author's expertise in the topic.

It is noted that for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, one or more of the following blocks may not be used: block 304, block 306, block 310, and block 312. Further, the topic-specific expertise score may be determined for the author without the personal influence score.

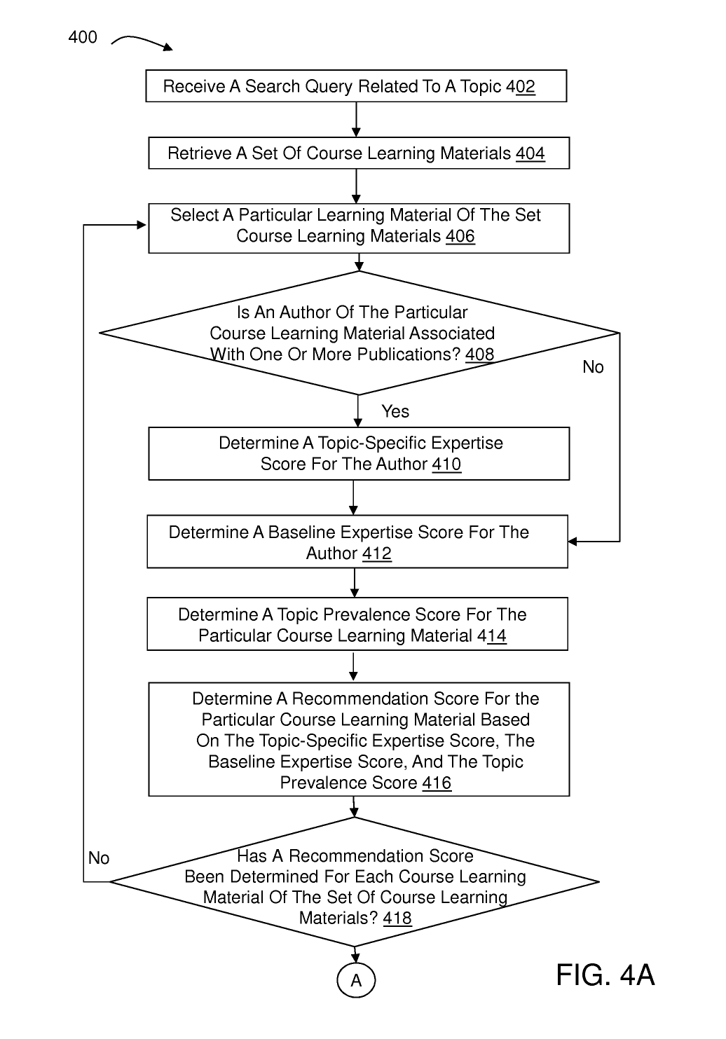

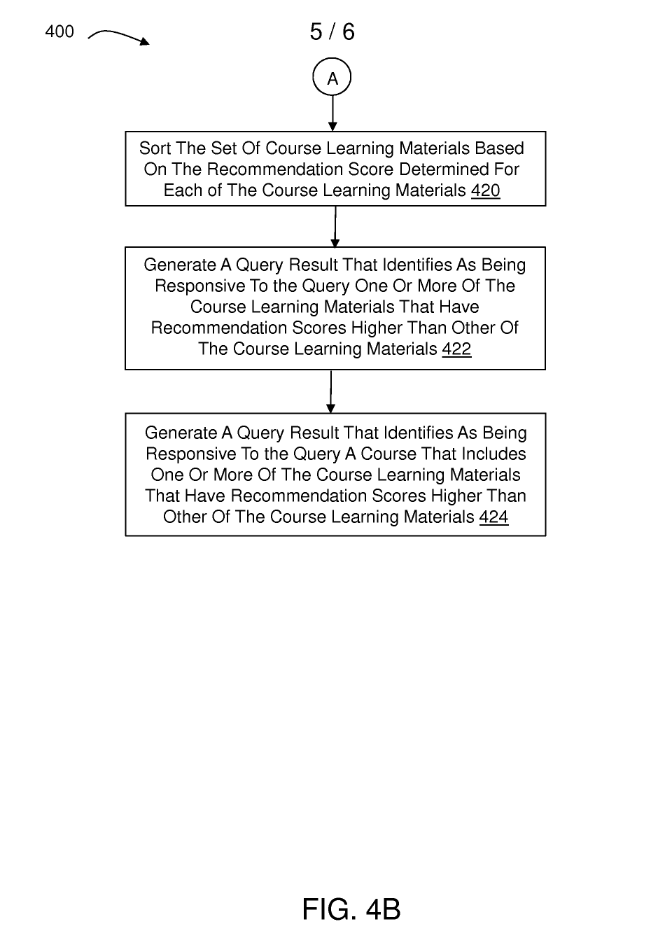

FIGS. 4A-4B illustrate an example flow diagram of another method 400 that may be implemented in the operating environment of FIG. 1, arranged in accordance with at least one embodiment described in the present disclosure. The method may begin at block 402. At block 402, a search query related to a topic may be received. Block 402 may be followed by block 404.

At block 404, a set of course learning materials may be retrieved. The set of course learning materials may include available course learning materials or a portion of the available course learning materials. Block 404 may be followed by block 406.

At block 406, a particular course learning material of the set of course learning materials may be selected. Block 406 may be followed by block 408.

At block 408, it may be determined whether an author of the particular course learning material is associated with one or more publications. The author may be associated with the one or more publications by, for example, being a named author of the one or more publications. Block 408 may be followed by block 410 if it is determined that the author of the particular course learning material is associated with one or more publications (“Yes” at block 410) or by block 412 if it is determined that the author of the particular course learning material is not associated with one or more publications (“No” at block 410).

At block 410, a topic-specific expertise score may be determined for the author. In some embodiments, the topic-specific expertise score may be determined according to the method 300. Block 410 may be followed by block 412.

At block 412, a baseline expertise score may be determined for the author. Block 412 may be followed by block 414.

At block 414, a topic prevalence score may be determined for the particular course learning material. In some embodiments, the topic prevalence score may be determined for the particular course learning material based on a relationship between a quantity of knowledge points extracted from the course learning material and a quantity of a subset of the knowledge points. The subset of the knowledge points may be associated with the topic. Block 414 may be followed by block 416.

At block 416, a topic-specific recommendation score may be determined for the particular course learning material based on the topic-specific expertise score, the baseline expertise score, and the topic prevalence score. In some embodiments, the topic-specific expertise score may be equal to, for example, zero (0) or one (1) when it is determined that the author is not associated with one or more publications so that the topic-specific expertise score does not affect calculation of the topic-specific recommendation score. Block 416 may be followed by block 418.

At block 418, it may be determined whether a topic-specific recommendation score has been determined for each course learning material of the set of course learning materials. Block 418 may be followed by block 420 if it is determined that a topic-specific recommendation score has been determined for each course learning material of the set of course learning materials (“Yes” at block 418) or by block 406 if is it determined that a topic-specific recommendation score has not been determined for each course learning material of the set of course learning materials.

At block 420, the set of course learning materials may be sorted based on the topic-specific recommendation score determined for each of the course learning materials. Block 420 may be followed by block 422.

At block 422, a query result may be generated that identifies as being responsive to the query one or more of the course learning materials that have topic-specific recommendation scores higher than other of the course learning materials. The query result may identify the course learning materials as being responsive to the query in the query search results by, for example, listing on a search query results page the course learning materials in order based on their respective topic-specific recommendation scores. The search query results page may be presented to the user on a computing device corresponding to the user. It is also contemplated that a query result may be generated that identifies as being responsive to the query one or more of the course learning materials that have topic-specific recommendation scores lower than other of the course learning material, depending, for example, on a particular formula used to determine the topic-specific recommendation score. Block 422 may be followed by block 424.

At block 424, a query result may be generated that identifies as being responsive to the query a course that includes one or more of the course learning materials that have recommendation scores higher than other of the course learning materials. For example, the course may include an online learning course that is selected from a set of online learning courses based on the first topic prevalence score, the second topic prevalence score, and the third topic prevalence score. In some embodiments, topic-specific recommendation scores for course learning materials in the online learning course, determined with respect to a particular topic, may be added together to equal a first sum, and the first sum may be compared with a second sum of topic-specific recommendation scores for other course learning materials in another online learning course, determined with respect to the particular topic. In some embodiments, the search query result, generated in response to a search query related to the particular topic, may identify the online learning course and/or the other online learning course as being responsive to the search query, depending on, for example, if the first and second sums of the topic-specific recommendation scores reach or exceed a threshold value. In some embodiments, the search query result may identify the online learning course as being responsive to the search query and not the other online learning course in response to the first sum being greater than the second sum.

It is noted that for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, topic-specific recommendation scores for the course learning materials of the set of course learning materials may be determined at the same time as opposed to sequentially. As another example, block 412 may not be used, and the topic-specific recommendation score for the particular course learning material may not be based on the baseline expertise score. As a further example, block 424 may not be used. As an additional example, block 422 may not be used.

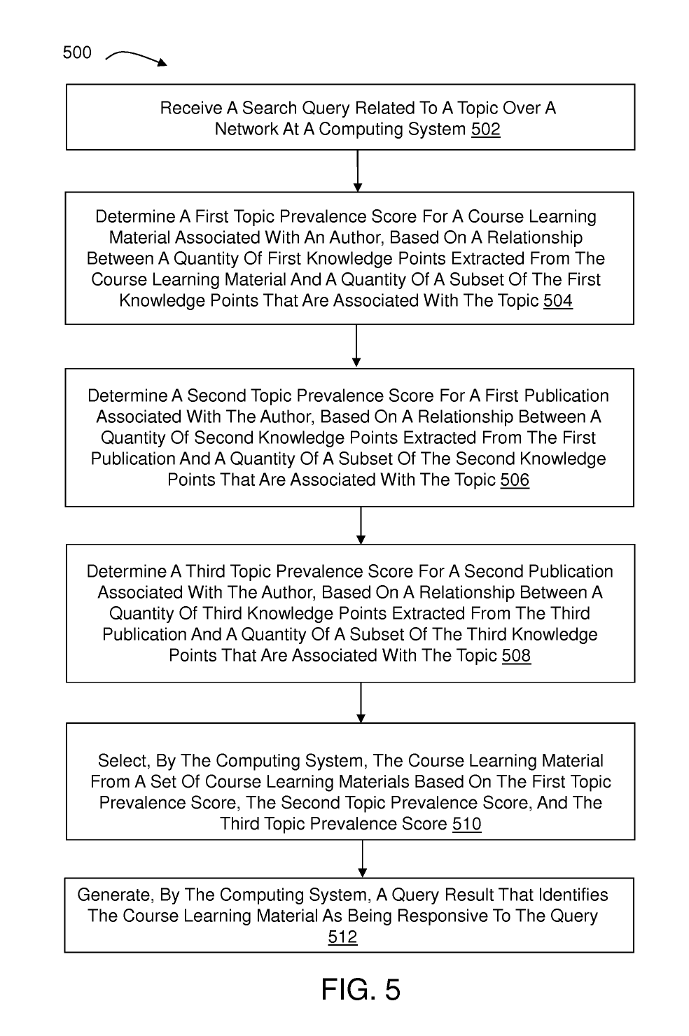

FIG. 5 illustrates an example flow diagram of a method 500 to process search queries for open education resources, arranged in accordance with at least one embodiment described in the present disclosure. The method 500 may begin at block 502. At block 502, a search query related to a topic may be received over a network at a computing system. In some embodiments, the computing system may include or correspond to the system 106 of FIG. 1 and/or FIG. 2. In some embodiments, the network may include or correspond to the network 102 of FIG. 1. Block 502 may be followed by block 504.

At block 504, a first topic prevalence score may be determined for a course learning material associated with an author, based on a relationship between a quantity of first knowledge points extracted from the course learning material and a quantity of a subset of the first knowledge points that are associated with the topic. Block 504 may be followed by block 506.

At block 506, a second topic prevalence score for a first publication associated with the author may be determined based on a relationship between a quantity of second knowledge points extracted from the first publication and a quantity of a subset of the second knowledge points that are associated with the topic. Block 506 may be followed by block 508.

At block 508, a third topic prevalence score may be determined for a second publication associated with the author, based on a relationship between a quantity of third knowledge points extracted from the third publication and a quantity of a subset of the third knowledge points that are associated with the topic. Block 508 may be followed by block 510.

At block 510, the course learning material may be selected by the computing system from a set of course learning materials based on the first topic prevalence score, the second topic prevalence score, and the third topic prevalence score. Block 510 may be followed by block 512.

At block 512, a query result that identifies the course learning material as being responsive to the query may be generated by the computing system.

It is noted that for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, block 508 may not be used when there is only a single publication associated with the author. As another example, block 506 and/or block 508 may not be used when there are no publications associated with the author.

FIG. 6 illustrates an example algorithm which may be used to generate a topic-specific expertise profile. In some embodiments, a co-author network and a citation network may be constructed based on publication meta-data MP, which may be extracted from multiple publications with a total number p. MP may be a vector of length p, and a total number of authors a may be extracted from the multiple publications. The co-author network may be an undirected graph, in which each node may represent an author, and an edge between two nodes may represent a co-author relation between two authors. The citation network may be a directed graph, in which each node may represent a publication, and an edge may represent a citation relation between two publications. Centrality metrics, for example, betweenness, may be used to measure personal influence of authors in the co-author network, and PageRank, for example, may be used to measure influence of publications in the citation network. Topic model analysis may reveal topic prevalences or distributions TDP of all p publications. If k is a number of topics selected, TDP may be a p×k matrix. As illustrated in FIG. 6, the topic-specific expertise profile EP for each author may be a a×k matrix, which may be generated, in some embodiments, based on TDP, PR, and CB, where PR represents a publication influence of the corresponding author and CB represents a personal influence of the corresponding author. In some embodiments, the topic prevalence, publication influence, and the personal influence may correspond to a topic prevalence score, publication influence score, and a personal influence score, respectively.

In some embodiments, topic model analysis may recover topic prevalences or distributions TDO of course materials. If there are c courses that contain m course learning materials, TDO may be a m×k matrix. Course metadata MO may be a vector of length m. Based on MO, all unique lecturers or authors may be extracted into a vector Lecturers of length l. Every author may be assigned a BASELINE, which may correspond to a baseline expertise score and which may be a constant vector of length k. If the author is also an author of one or more publications, a topic-specific expertise score EP may be added to at least the baseline expertise score.

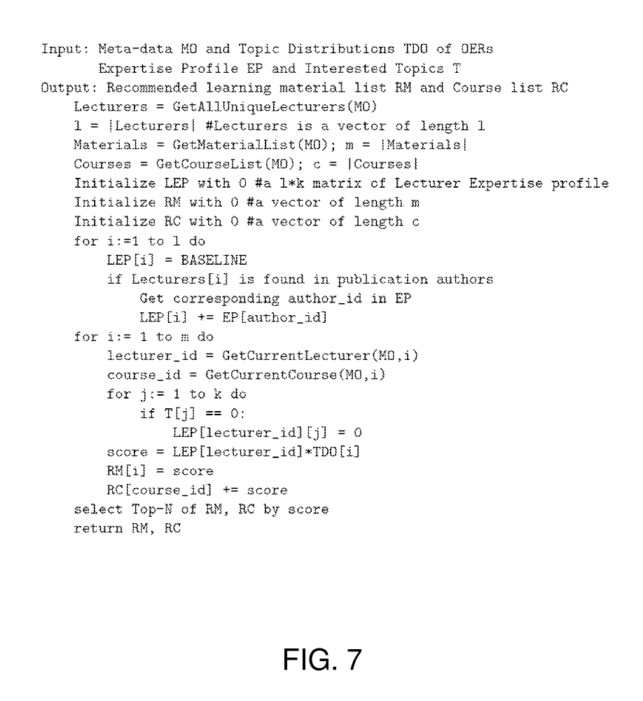

FIG. 7 illustrates an example algorithm which may be used to generate a topic-specific recommendation score. In some embodiments, interested topics T of a user may be determined based on a search query entered by the user. While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computer-implemented method to process search queries for open education resources, the method comprising:
receiving a search query related to a topic over a network at a computing system;
selecting, by the computing system, a course learning material from a set of course learning materials based on a first topic prevalence score for the learning material, a second topic prevalence score for a first publication, and a third topic prevalence score for a second publication; and
generating, by the computing system, a search query result that identifies the course learning material as being responsive to the search query, wherein before receiving the search query, the computer-implemented method comprises:
determining the first topic prevalence score for the course learning material based on a relationship between a quantity of a plurality of first knowledge points extracted from the course learning material and a quantity of a subset of the plurality of first knowledge points that are associated with the topic, the course learning material associated with an author;
determining the second topic prevalence score for the first publication based on a relationship between a quantity of a plurality of second knowledge points extracted from the first publication and a quantity of a subset of the plurality of second knowledge points that are associated with the topic, the first publication associated with the author; and
determining the third topic prevalence score for the second publication based on a relationship between a quantity of a plurality of third knowledge points extracted from the second publication and a quantity of a subset of the plurality of third knowledge points that are associated with the topic, the second publication associated with the author.

2. The method of claim 1, further comprising:
determining a personal influence score of the author based on one or more measurements obtained from a co-author network constructed from the set of course learning materials;
determining a second publication influence score and a third publication influence score based on one or more measurements obtained from a citation network constructed from the set of course learning materials;
determining a topic-specific expertise score for the author based on the second topic prevalence score, the third topic prevalence score, the personal influence score, the second publication influence score, and the third publication influence score; and
determining a topic-specific recommendation score for the course learning material based on the topic-specific expertise score and the first topic prevalence score,
wherein, the course learning material is selected by the computing system based on the topic-specific recommendation score that is based on the first topic prevalence score, the second topic prevalence score, and the third topic prevalence score.

3. The method of claim 2, wherein the topic-specific expertise score is determined according to the formula ES=PI×(Σᵢ₌₁ⁿAᵢ×Tᵢ), where ES is the topic-specific expertise score, PI is the personal influence score of the author, n is a total number of the publications associated with the author in the set of course learning materials, Aᵢ with i ranging from 1 to n is an publication influence score of each of the n number of publications, and Tᵢ with i ranging from 1 to n is a topic prevalence score of each of the n number of publications, wherein Aᵢ includes the second publication influence score and the third publication influence score and Tᵢ includes the second topic prevalence score and the third topic prevalence score.

4. The method of claim 2, wherein the one or more measurements obtained from the co-author network include a centrality of the author in the co-author network.

5. The method of claim 2, further comprising determining a baseline expertise score for the author based on a total quantity of knowledge points with topic labels in course learning materials associated with the author in the set of course learning materials,
wherein determining the topic-specific recommendation score for the course learning material is further based on the baseline expertise score.

6. The method of claim 5, wherein the topic-specific recommendation score is determined according to the formula RS=(ES+B)×FT, where RS is the topic-specific recommendation score, ES is the topic-specific expertise score, B is the baseline expertise score, and FT is the first topic prevalence score.

7. The method of claim 1, further comprising:
selecting, by the computing system, an online learning course that includes the course learning material from a set of online learning courses based on the first topic prevalence score, the second topic prevalence score, and the third topic prevalence score; and
generating, by the computing system, a search query result that further identifies the online learning course as being responsive to the search query.

8. A system to process search queries for open education resources, the system comprising a processor configured to:
receive a search query related to a topic over a network at a computing system;
select, by the computing system, course learning material from a set of course learning materials based on a first topic prevalence score for the course learning material, a second topic prevalence score for a first publication, and a third topic prevalence score for a second publication; and
generate, by the computing system, a search query result that identifies the course learning material as being responsive to the search query, wherein before receiving the search query, the processor is configured to:
determine the first topic prevalence score for the course learning material based on a relationship between a quantity of a plurality of first knowledge points extracted from the course learning material and a quantity of a subset of the plurality of first knowledge points that are associated with the topic, the course learning material associated with an author;
determine the second topic prevalence score for the first publication based on a relationship between a quantity of a plurality of second knowledge points extracted from the first publication and a quantity of a subset of the plurality of second knowledge points that are associated with the topic, the first publication associated with the author; and
determine the third topic prevalence score for the second publication based on a relationship between a quantity of a plurality of third knowledge points extracted from the second publication and a quantity of a subset of the plurality of third knowledge points that are associated with the topic, the second publication associated with the author.

9. The system of claim 8, wherein the processor is further configured to:
determine a personal influence score of the author based on one or more measurements obtained from a co-author network constructed from the set of course learning materials;
determine a second publication influence score and a third publication influence score based on one or more measurements obtained from a citation network constructed from the set of course learning materials;
determine a topic-specific expertise score for the author based on the second topic prevalence score, the third topic prevalence score, the personal influence score, the second publication influence score, and the third publication influence score; and
determine a topic-specific recommendation score for the course learning material based on the topic-specific expertise score, the baseline expertise score, and the first topic prevalence score,
wherein, the course learning material is selected by the computing system based on the topic-specific recommendation score that is based on the first topic prevalence score, the second topic prevalence score, and the third topic prevalence score.

10. The system of claim 9, wherein the processor is further configured to determine the topic-specific expertise score according to the formula ES=PI×(Σᵢ₌₁ⁿAᵢ×Tᵢ), where ES is the topic-specific expertise score, PI is the personal influence score of the author, n is a total number of the publications associated with the author in the set of course learning materials, Aᵢ with i ranging from 1 to n is an publication influence score of each of the n number of publications, and Tᵢ with i ranging from 1 to n is a topic prevalence score of each of the n number of publications, wherein Aᵢ includes the second publication influence score and the third publication influence score and Tᵢ includes the second topic prevalence score and the third topic prevalence score.

11. The system of claim 9, wherein the one or more measurements obtained from the co-author network include a centrality of the author in the co-author network.

12. The system of claim 9, wherein the processor is further configured to determine a baseline expertise score for the author based on a total quantity of knowledge points with topic labels in course learning materials associated with the author in the set of course learning materials,
wherein the processor is configured to determine the topic-specific recommendation score for the course learning material further based on the baseline expertise score.

13. The system of claim 12, wherein the processor is further configured to determine the topic-specific recommendation score according to the formula RS=(ES+B)×FT, where RS is the topic-specific recommendation score, ES is the topic-specific expertise score, B is the baseline expertise score, and FT is the first topic prevalence score.

14. The system of claim 8, further comprising:
selecting, by the computing system, an online learning course that includes the course learning material from a set of online learning courses based on the first topic prevalence score, the second topic prevalence score, and the third topic prevalence score; and
generating, by the computing system, a search query result that further identifies the online learning course as being responsive to the search query.

15. One or more non-transitory computer-readable media that include instructions stored thereon that are executable by one or more processors to perform or control performance of operations to process search queries for open education resources, the operations comprising:
receiving a search query related to a topic over a network at a computing system;
selecting, by the computing system, a course learning material from a set of course learning materials based on a first topic prevalence score for the course learning material, a second topic prevalence score for a first publication, and a third topic prevalence score for a second publication; and
generating, by the computing system, a search query result that identifies the course learning material as being responsive to the search query, wherein before receiving the search query, the computer-implemented method comprises:
determining the first topic prevalence score for the course learning material based on a relationship between a quantity of a plurality of first knowledge points extracted from the course learning material and a quantity of a subset of the plurality of first knowledge points that are associated with the topic, the course learning material associated with an author;
determining the second topic prevalence score for the first publication based on a relationship between a quantity of a plurality of second knowledge points extracted from the first publication and a quantity of a subset of the plurality of second knowledge points that are associated with the topic, the first publication associated with the author; and
determining the third topic prevalence score for the second publication based on a relationship between a quantity of a plurality of third knowledge points extracted from the second publication and a quantity of a subset of the plurality of third knowledge points that are associated with the topic, the second publication associated with the author.

16. The non-transitory computer-readable media of claim 15, wherein the operations further comprise:
determining a personal influence score of the author based on one or more measurements obtained from a co-author network constructed from the set of course learning materials;
determining a second publication influence score and a third publication influence score based on one or more measurements obtained from a citation network constructed from the set of course learning materials;
determining a baseline expertise score for the author based on a total quantity of knowledge points with topic labels in course learning materials associated with the author in the set of course learning materials;
determining a topic-specific expertise score for the author based on the second topic prevalence score, the third topic prevalence score, the personal influence score, the second publication influence score, and the third publication influence score; and
determining a topic-specific recommendation score for the course learning material based on the topic-specific expertise score, the baseline expertise score, and the first topic prevalence score,
wherein, the course learning material is selected by the computing system based on the topic-specific recommendation score that is based on the first topic prevalence score, the second topic prevalence score, and the third topic prevalence score.

17. The non-transitory computer-readable media of claim 16, wherein the topic-specific recommendation score is determined according to the formula RS=(ES+B)×FT, where RS is the topic-specific recommendation score, ES is the topic-specific expertise score, B is the baseline expertise score, and FT is the first topic prevalence score.

18. The non-transitory computer-readable media of claim 16, wherein the topic-specific expertise score is determined according to the formula ES=PI×(Σᵢ₌₁ⁿAᵢ×Tᵢ), where ES is the topic-specific expertise score, PI is the personal influence score of the author, n is a total number of the publications associated with the author in the set of course learning materials, Aᵢ with i ranging from 1 to n is an publication influence score of each of the n number of publications, and Tᵢ with i ranging from 1 to n is a topic prevalence score of each of the n number of publications, wherein Aᵢ includes the second publication influence score and the third publication influence score and Tᵢ includes the second topic prevalence score and the third topic prevalence score.

19. The non-transitory computer-readable media of claim 16, wherein the one or more measurements obtained from the co-author network include a centrality of the author in the co-author network.

20. The non-transitory computer-readable media of claim 15, wherein the operations further comprise:
selecting, by the computing system, an online learning course that includes the course learning material from a set of online learning courses based on the first topic prevalence score, the second topic prevalence score, and the third topic prevalence score; and
generating, by the computing system, a search query result that further identifies the online learning course as being responsive to the search query.
